(19) United States
(12) Patent Application Publication
(10) Pub. No.: US 2010/0107469 A1
(43) Pub. Date: May 6, 2010

(54) Noise-emitting lure

(76) Inventors: William E. Dunkerley, McDonough, GA (US); William G. Dunkerley, McDonough, GA (US)

Correspondence Address: CURTIS L. HARRINGTON, 6300 STATE UNIVERSITY DRIVE, SUITE 250, LONG BEACH, CA, 90815, US

(21) Appl. No.: 12/589,835

(22) Filed: Oct. 29, 2009

Related U.S. Application Data
(60) Provisional application No. 61/198,063, filed on Nov. 3, 2008.

(51) Int. Cl. A01K 85/01

(52) U.S. Cl. 43/42.31

(57) ABSTRACT

The lure of the present invention may include a main housing and one or more tumblers which may tumble and strike the inside walls of the main housing when the lure is rotated, resulting in emission of a fish-attractive clicking noise. The main housing may be fitted with one or more swivel eyelet members for tangle-free line and tackle attachment. The lure may include one or more spinner blades or propeller blades to drive rotation of the main housing. The main housing and/or tumbler(s) may be any of a variety of shapes, sizes, and lengths to create sounds in a wide range of frequencies for catching different kinds of fish, and materials from which the main housing and tumbler(s) are made may further impact frequency, pitch, and range of sound emitted.

### FIELD OF THE INVENTION

The present invention relates to the field of fishing lures, and more particularly to noise-emitting lure which may be used in combination with a limitless variety of jigs, spinners, blades, hooks, and other fishing tackle and which, when activated, may emit discrete sound waves at frequencies known to attract fish within range of their sensation.

### BACKGROUND OF THE INVENTION

Noise-emitting lures used to attract fish are known in the fishing industry. A wide variety of both analog and digital noise-emitting lures are currently available. Some noise-emitting lures come pre-assembled with hooks, blades, jigs, spinners or other fishing tackle. A pre-assembled lure having fixed components, however, is not always optimal, especially if a fisher prefers to use particular tackle arrangements for different fishing conditions such as location, weather, visibility, or water temperature, for example.

One of the more well-known conventionally available noise-emitting lures is a rattle lure such as the RAT-L-TRAP. Rattle lures are typically fish-shaped lures that are designed to undulate as they are pulled through the water. The undulating motion activates an internal mechanism that causes the lure to emit a fish-attractive rattle. This kind of lure generally includes a number of eye-loops on the underside and/or back end for attaching hooks, and also typically includes an eye loop on the top side (if the lure is a floating type lure) or lip (if the lure is a deep-water diving type lure) for attaching a fishing line. Because there are multiple sets of hooks which are in close proximity to each other and to the line, one problem with this kind of lure is that the hooks continually become caught in each other or caught on the line. In either situation, entanglement of the hooks or any other condition that interferes with the undulating motion disables the sound emission of the lure. Consequently, the lure must be retrieved, disentangled, and re-cast in order to achieve proper sound performance. Failed casts absorb user energy, result in lost fishing time, and can be incredibly frustrating regardless of whether fishing is engaged in for leisurely purposes or as a competitive endeavor.

With regard to electronic versions of noise-emitting lures, there is always the possibility of malfunction. In electronic lures which depend upon a self contained, limited capacity energy source to emit sound, failure of the power source is inevitable. Where the noise-emitting component of an electronic lure is completely enclosed, there may be no means of access for repair or power source replacement should any of the electronic elements malfunction. For lures in which access to the noise-emitting element is an option, the issue becomes one of frequent battery changes. Further, even where the noise emitting element of an electronic lure is accessible, there is a possibility that water leakage will occur and will cause irreversible damage to the electronic components.

Another disadvantage of conventionally available noise-emitting lures is cost. Many start at a retail cost of about $12 or more. Where different colors, shapes, sizes or configurations of tackle are desired, owning a variety of lures to suit an array possible fishing conditions can become prohibitively expensive.

What is therefore needed is an affordable, high quality noise-emitting lure which may be utilizable as an in-line modular component that may be selectably used with a limitless combination of attachments such as hooks, blades, jigs, spinners, and various other fishing tackle at the whim of the fisher. The noise-making mechanism of the ideal noise-emitting lure may be one of several non-electronic analog configurations, is not dependent on a power source, and is not prone to water leakage, drag, or entanglement of attached tackle. Finally, the ideal noise-emitting lure may come in a variety of shapes and sizes, may be used in fresh water or in salt water conditions, and may be color customized and/or camouflaged to suit a wide range of fishing needs.

### SUMMARY OF THE INVENTION

The noise-emitting lure of the present invention may include a main housing which may be any of a variety of shapes, including circular, square, scalloped, or angled cylindrical (any of which may be tapered or untapered); spherical; rectangular; or pyramidal, just to name a few. Likewise, the main housing may be any of a variety of lengths and sizes which may be varied according to the type and size of the target fish. The main housing may ideally be fitted with a swivel eyelet member at one end, to which a split ring, carabiner, or similar connector may be connected to accommodate line attachment or attachment of other tackle. The lure of the present invention may also include a second eyelet member at its opposite end which may be swivel or non-swivel.

The lure of the present invention may include one or more permanently affixed spinner blades or propeller blade(s) so that, as the lure is pulled through water, a pressure gradient results which causes the propeller blade(s) to rotate, which will, in turn, cause rotational movement of the main housing. Alternatively, rotation of the main housing may be achieved by attaching any of a variety of interchangeable blades or spinners to a non-swivel eyelet member on the lure.

Rotation of the main housing may ideally cause one or more tumblers contained within the main housing to tumble and strike the inside walls of the main housing so that a fish-attractive sound or click is emitted. Where the main housing of the lure is circular cylindrical, the tumbler(s) inside the main body may ideally be polygonal, such as a triangle, rectangle, hexagon, octagon or the like, the number of sides of which, along with the rotational speed of the main housing, will help to determine the frequency of clicks emitted by the lure. Further, the type and gauge of material from which the main housing and tumblers are constructed may help to determine the intensity and pitch of the clicks emitted from the lure. The inner walls of the main housing may be smooth, angled, ribbed, or otherwise textured to further affect the frequency of clicks emitted as well as the quality of sound of the clicks.

The lure of the present invention may ideally be constructed of a lightweight metal such as aluminum, but may be constructed of brass or any other material of a type and gauge which readily transmits sound of desired quality.

### BRIEF DESCRIPTION OF THE DRAWINGS

The invention, its configuration, construction, and operation will be best further described in the following detailed description, taken in conjunction with the accompanying drawings in which:

FIG. 1 is an exploded perspective view of a first embodiment of the lure of the present invention which illustrates a cylindrical main housing, a rectangular tumbler member, a swivel eyelet member, a fixed eyelet member, a locking endcap, and a friction-fit endcap;

FIG. 2 is a perspective view of the lure of FIG. 1 as assembled;

FIG. 3 is a cross-sectional view taken along line 3-3 of FIG. 2 which illustrates one system of characterizing clearance between the rectangular tumbler member and the cylindrical main housing;

FIG. 4 is a is a perspective view of a spinner bait arrangement including a second embodiment of the lure of the present invention having a pair of rib members, attached to a spinner bait, and containing a spherical tumbler member and an octagonal tumbler member;

FIG. 5 is a cross-sectional view taken along line 5-5 of FIG. 4 which illustrates main housing, spherical tumbler member, octagonal tumbler member, and 2 rib members;

FIG. 6 is a perspective view of a third embodiment of the lure of the present invention which illustrates a ribbed or gear shaped main housing;

FIG. 7 is a cross-sectional view taken along line 7-7 of FIG. 6 which illustrates a cylindrical tumbler member inside the gear-shaped main housing;

FIG. 8 is a perspective view of a fourth embodiment of the lure of the present invention which illustrates an octagonally shaped main housing;

FIG. 9 is a cross-sectional view taken along line 9-9 of FIG. 8 which illustrates clearance between a cylindrical tumbler member interior octagonal shaped main housing;

FIG. 10 is a perspective view of a fifth embodiment of the lure of the present invention having a swivel eyelet member at each end of a cylindrical main housing and having fixed propeller blades adjacent one end;

FIG. 11 is a perspective view of a sixth embodiment of the lure of the present invention having a cylindrical main housing, fixed endcaps, and fixed o-rings, to which a swivel eyelet member, a hook, and a line are shown attached;

FIG. 12 is a perspective view of a seventh embodiment of the lure of the present invention which illustrates a cylindrical main housing with a closed end, a rectangular tumbler member, a swivel eyelet member, a fixed eyelet member, and two locking endcaps;

FIG. 13 is a cross-sectional view taken along line 13-13 of FIG. 12 which illustrates the cylindrical main housing with closed end;

FIG. 14 is an cross-sectional view similar to that illustrated in FIG. 13 which illustrates an alternative closed-ended arrangement of a cylindrical main housing which includes an integral eyelet; and

FIG. 15 is a perspective view of a eighth embodiment of the lure of the present invention which is nearly identical to the embodiment of FIG. 6 except for being spirally milled.

### DETAILED DESCRIPTION OF THE PREFERRED EMBODIMENT

The invention, its configuration, construction, and operation will be best further described in the following detailed description, taken in conjunction with the accompanying drawings in which:

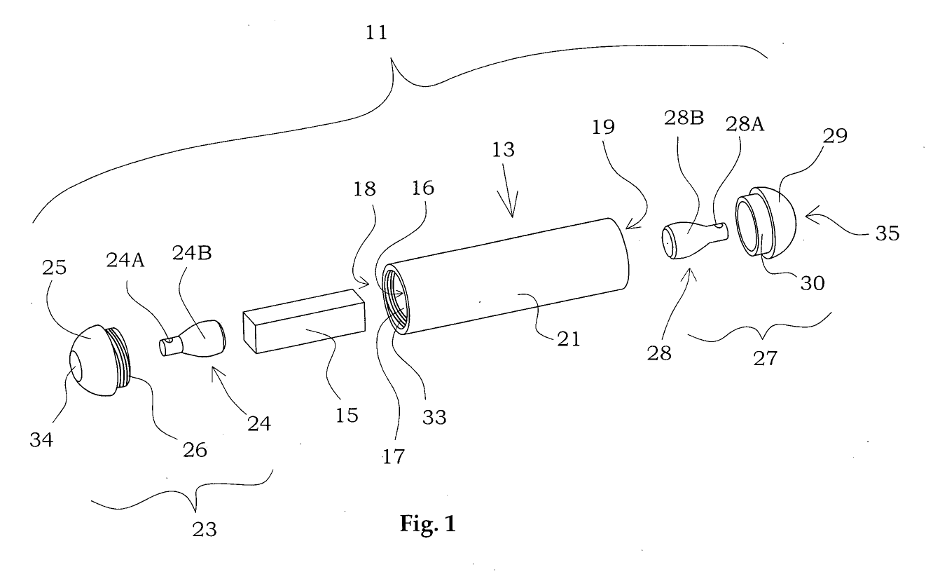

FIG. 1 is an exploded perspective view of a first embodiment of the lure of the present invention which illustrates a noise-emitting lure 11, including a main housing 13 and a tumbler member 15. Main housing 13 includes an interior space 16 defined by inner surface 17 and also includes an outer surface 21. In FIG. 1, main housing 13 is illustrated as having a first open end 18 and a second open end 19. Although main housing 13 is illustrated as cylindrical and tumbler member 15 is illustrated as rectangular, either may be any of a wide variety of shapes and sizes which allow for sufficiently free movement of tumbler member 15 so that it tumbles inside housing 13 when lure 11 is rotated. tumbler member 15 may be provided in plural with a qualification that it not become stuck or jammed either with respect to inner surface 17, nor with other tumbler members 15 where more than one tumbler member 15 is present.

Illustrated adjacent tumbler member 15, is a first eyelet assembly 23, which may include first eyelet member 24, having eyelet 24A and body 24B, along with first endcap 25 having a threaded flange 26. A second eyelet assembly 27 is shown adjacent housing 13 and may include second eyelet member 28, which is a swivel eyelet member 28 having eyelet 28A and body 28B, along with second endcap 29 having a smooth flange 30. Eyelet 24A is illustrated as rotatable with respect to body 24B, and eyelet 28A is illustrated as fixed with respect to body 28B, although either eyelet 24A or 28A may rotate with respect to bodies 24B and 28B or with respect to any structures supporting eyelet members 24 and 28. First eyelet member 24 may be a ball-bearing type or any other type that allows for 360 degree rotation. Further, second eyelet assembly 27 is illustrated as including an eyelet member, but may be any attachment structure, such as a button, a rivet, a hook, or any other structure which allows for attachment of various components to lure 11.

Endcaps 25 and/or 29 may be attachable to housing 13 by any number of methods, as previously mentioned. Threaded flange 26 illustrates one possible locking mechanism by which first endcap 25 may be coupled with first open end 18 of main housing 13, which may include threads 33 into which threaded flange 26 of endcap 25 may be screwed. Second endcap 29 is shown as having a smooth flange 30 to illustrate a possible friction-fit mechanism by which second endcap 29 may be coupled with second open end 19 of main housing 13. First and second endcaps 25 and 29 may include openings 34 and 35 (opening 35 not immediately seen in FIG. 1), respectively, through which eyelet members 24 and 28 may extend, respectively, when lure 11 is assembled or may include other structures for attachment.

Endcaps 25 and 29 may be joined with main housing 13 by any number of means, such as adhesive, soldering or welding, or locking mechanisms, for example, and other water-resistant or waterproof fixative or sealant to prevent water ingress into main housing 13 may be used in conjunction with any of the above. It is also possible for first endcap 25 and first eyelet member 24 to be provided as an integral unit, as could also be the case for second endcap 29 and second eyelet member 28. Where endcaps 25 and 29 are coupled with main housing 13 using adhesive, tensile strength may be approximately 15 to 20 pounds, which may be sufficient to prevent disassembly of lure 11 when it is not directly in line with a hook. Where lure 11 may be in line with a hook, endcaps 25 and 29 may preferably be joined to housing soldering or welding or a locking mechanism to increase tensile strength beyond 15 to 20 pounds as may be necessary. Further, electro plating or powder coating of lure 11 may be desirable to further increase tensile strength of lure 11. Endcaps 25 and 29 are illustrated as domed, but may be any shape, including rounded, flat, or pointed, for example. Main housing 13 and endcaps 25 and 29 may be made from any of a variety of materials, including but not limited to wood, plastic, or metal. Likewise, eyelet members 24 and 28 may be sealed to endcaps 25 and 29, respectively, by any number of means or combinations of means, including adhesive, welding or soldering, or locking mechanism.

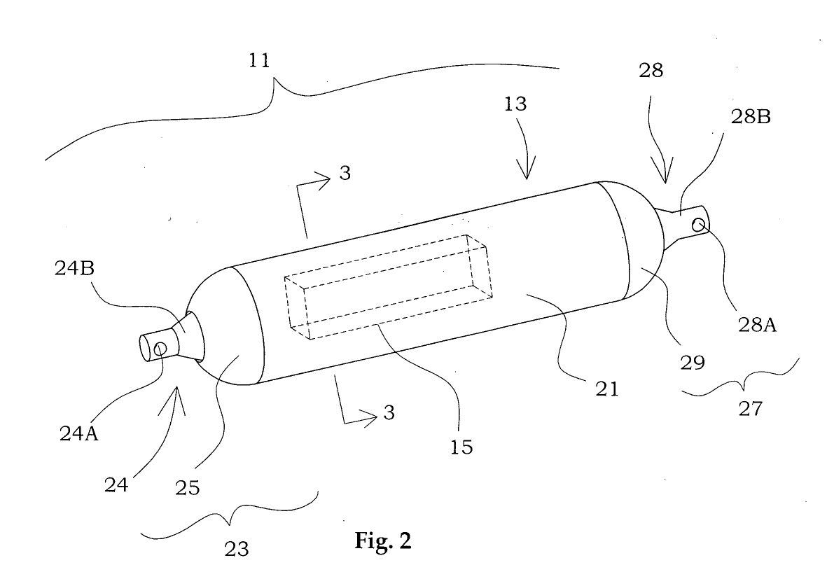

FIG. 2 is a perspective view of lure 11 of FIG. 1 as assembled, including main housing 13, tumbler member 15 shown in dashed line format inside main housing 13, first eyelet member 24, second eyelet member 28, first endcap 25, and second endcap 29. Once lure 11 is assembled, endcaps 25 and 29 may be welded, soldered, glued, or otherwise affixed (depending on the materials from which lure 11 is constructed) to main housing 13 and eyelet members 24 and 28 to preferably completely seal tumbler member 15 inside main housing 13 such that water is prevented from seeping into main housing 13 if desired. Water entry may be undesirable and would otherwise affect the sound emitted, based upon the density and shape of tumbler member 15, its ability to admit water within its tumbler member 15 body, and other considerations.

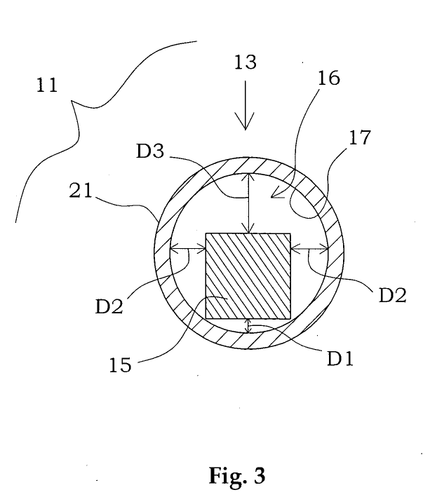

FIG. 3 is a cross-sectional view of lure 11 of FIGS. 1 and 2 which illustrates one system to show relative clearance between tumbler member 15 and main housing 13. Assuming lure 11 is not in motion, and viewing D1 as the distance between a resting main flat surface of tumbler member 15 and inner surface 17 of main housing 13, then the preferable minimum distance between a main flat surface of tumbler member 15 and inner surface 17 of main housing 13 labeled D2 may be approximately twice distance D1, and the preferred minimum distance between a main flat surface of tumbler member 15 and inner surface of main housing 13 labeled D3 may be approximately four times distance D1.

A system for measuring clearance between the corner of tumbler member 15 and inner surface 17 of main housing 13 may also be employed, and choice of alternate systems may be more convenient based upon the shape of tumbler member 15, such as measuring distance from corners of tumbler member 15, for example. The minimum clearance described may allow tumbler member 15 to be sufficiently unrestricted so that it turns over and tumbles freely when main housing 13 is rotated, emitting a fish-attractive clicking noise. Main housing 13 and tumbler member 15 may be constructed of from a wide range of materials, such as aluminum, stainless, or brass, with an eye toward buoyancy, density, admission of water into interior space 16 or sealed interior space 16, minimization of corrosion, etc., but may ideally be designed so that the friction coefficient between main housing 13 and tumbler member 15 is high enough to cause tumbler member 15 to turn over inside main housing 13 rather than slip along inner surface 17 of main housing 13 when main housing 13 is rotated.

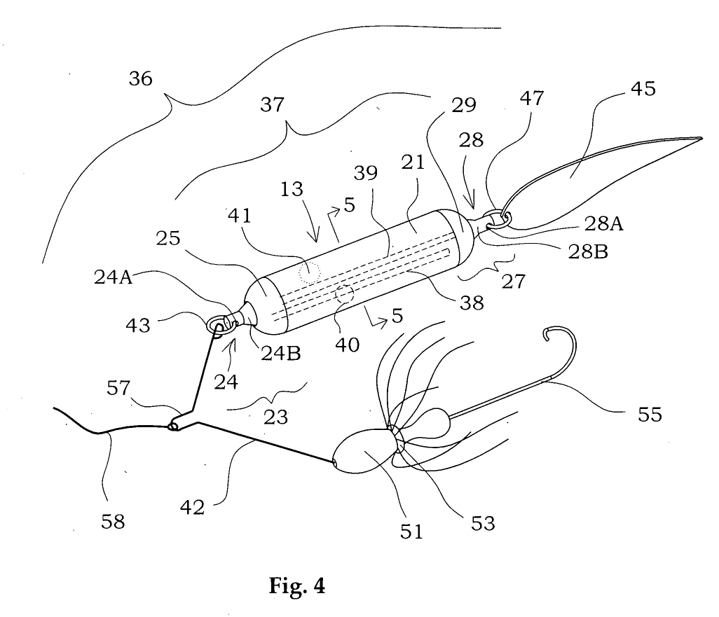

FIG. 4 is a is a perspective view of a spinner bait arrangement 36 in which a second embodiment of lure of the present invention 37 is incorporated. Lure 37 is nearly identical to lure 11 of FIGS. 1 and 2 except that main housing 13 includes rib members 38 and 39, shown in dashed line format, running longitudinally, and FIG. 4 also illustrates in dashed line format a spherical tumbler member 40 and an octagonal tumbler member 41 inside main housing 13. Also illustrated in FIG. 4 are eyelet members 24 and 28 and endcaps 25 and 29. Lure 37 is shown attached to a preferably rigid spinner bait wire 42 by ring 43 through eyelet 24A of first eyelet member 24 and to a spinner blade 45 by ring 47 through eyelet 28A at second eyelet member 28. A spinner bait head 51 with skirt 53 and hook 55 is also attached to what may be a generally rigid spinner bait wire 42. Spinner bait wire 42 may include a bend 57 or other specialized structure to which a fishing line 58 is shown attached. As spinner bait 36 is pulled through the water by line 58, blade 45 may rotate and may exert torque on second eyelet member 28 and, in turn, on main housing 13, causing tumbler members 40 and 41 to turn over or tumble inside main housing 13 impacting rib members 38 and 39 and inner surface 17 of main housing 13 such that lure 37 is caused to emit a fish-attractive noise or click. First eyelet member 24 may isolate the passive torque from movement of lure 37 so that the rotation created by blade 45 does not translate to spinner bait wire 42, line 58, spinner bait head 51 or hook 55. Note that spinner bait wire 42, spinner blade 45, spinner bait head 51, and line 58 are just a few of hundreds of components which can be assembled to utilize one of the many ways in which lure 37 (or any other embodiment of the lure of the present invention) can be successfully combined with currently available fishing tackle to create a custom spinner bait arrangement.

Like all embodiments of the lure of the present invention described herein, sound emitted by lure 37 may be sensible from as many as 7 feet or more underwater, and may mimic the sound of an injured or distressed baitfish, as such a low-frequency sound is known to attract predator fish. Because lure 37 may be sensed by fish from a significant distance, it may draw predator fish to the prey, which may be a distinct advantage over commonly available reaction lures. Reaction lures typically create sudden movement in order to mimic the movement that occurs when prey, such as a worm, bug, or frog, for example, falls into water near a fish. The goal of a reaction lure is typically to provoke a sudden attack by a fish, but in the case where no fish are in the immediate vicinity of a reaction lure, this kind of lure may generally be less reliable for catching fish than noise-making lures such as the lures of the present invention.

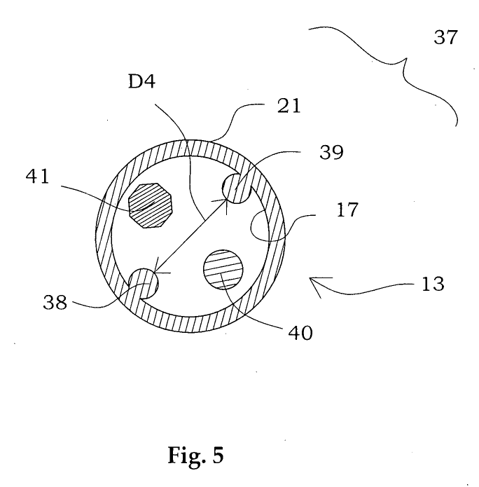

FIG. 5 is a cross-sectional view of lure 37 taken along line 5-5 of FIG. 4 which more clearly illustrates rib members 38 and 39 which extend radially inward from inner surface 17, spherical tumbler 40, and octagonal tumbler member 41. Note that although tumbler members 40 and 41 are illustrated as spherical and octagonal, respectively, they may also be polygonal, i.e., hexagonal, triangular, or octagonal, for example. Additionally, tumbler members may vary with regard to overall length. The diameter of tumbler members 40 and/or 41 is preferably one to two millimeters less than distance D4 between rib members 38 and 39, at a minimum, to allow tumbler members 40 and 41 to roll over and pass between rib members 38 and 39 as main housing 13 is rotated. Although FIG. 4 illustrates main housing 13 as containing two tumbler members 40 and 41, it is conceivable that more than two tumbler members may be contained, in which case the sum of the tumbler diameters may preferably be less than the critical clearance to allow multiple tumblers to freely pass between and around rib members 38 and 39.

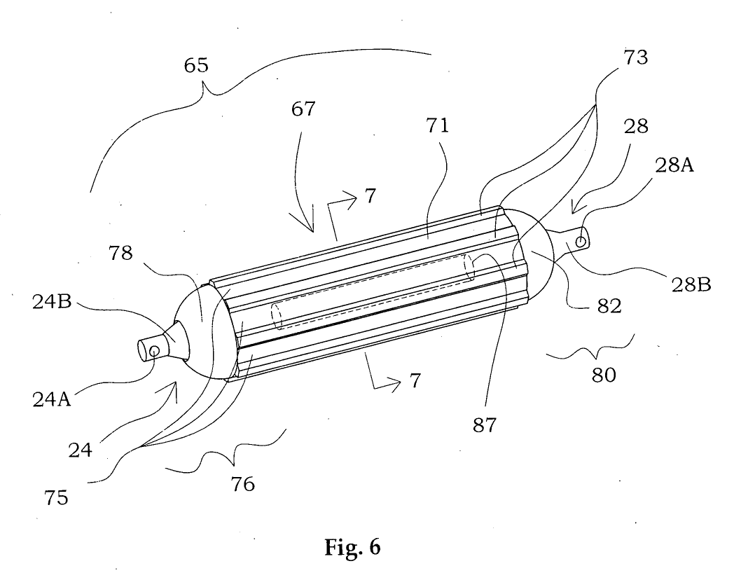

FIG. 6 is a perspective view of a third embodiment of the lure of the present invention 65 which is similar to lure 11 of FIGS. 1 and 2 except that lure 65 includes a gear-shaped main housing 67 having an outer surface 71 which is characterized by longitudinally situated peaks 73 and troughs 75. Like lure 11 of FIGS. 1 and 2, lure 65 may include a first eyelet assembly 76, which may include a swivel eyelet member 24, having eyelet 24A and body 24B, along with first endcap 78. Lure 65 may also include second eyelet assembly 80, which may include a fixed eyelet member 28 having eyelet 28A and body 28B, along with second endcap 82. A cylindrical tumbler member 87 is illustrated in dashed line format inside main housing 67.

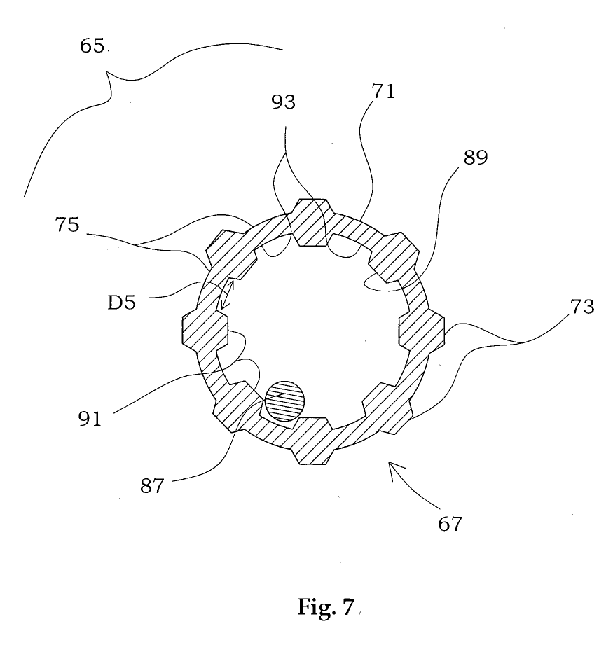

FIG. 7 is a cross-sectional view of lure 65 taken along line 7-7 of FIG. 6 which illustrates an inner surface 89 of main housing 67 characterized by longitudinally situated peaks 91 and troughs 93 similar to outer surface 71. Cylindrical tumbler member 87 is illustrated inside main housing 67. During use, tumbler member 87 may roll over peaks 91 and into troughs 93 to cause lure 65 to emit fish-attractive sounds or clicks. The diameter of tumbler member 87 may preferably be no greater than the width of trough 93 so that the clicks emitted from lure 65 are distinct, low-frequency clicks similar to the sounds made by injured or distressed baitfish, which are known to attract fish.

The density of material from which tumbler member 87 is constructed may preferably be sufficiently heavy, and the friction coefficient between inner surface 89 of main housing 67 and tumbler member 87 may preferably be high enough to ensure that, regardless of the rate at which main housing 67 is rotated, the timing of the clicks emitted will be appropriately spaced. Likewise, the friction coefficient may preferably not be so high as to repeatedly pick up and displace tumbler member 87 so as to interfere with the desired sounds emitted by lure 65. Note that although outer surface 71 of main housing 67 is illustrated as gear shaped, it may just as easily be a smooth surface such as illustrated for main housing 13 of FIGS. 1 through 3. Likewise, although tumbler member 87 is illustrated as cylindrical, it may also be polygonal, i.e., rectangular, hexagonal, triangular, or octagonal, and may vary in length as well.

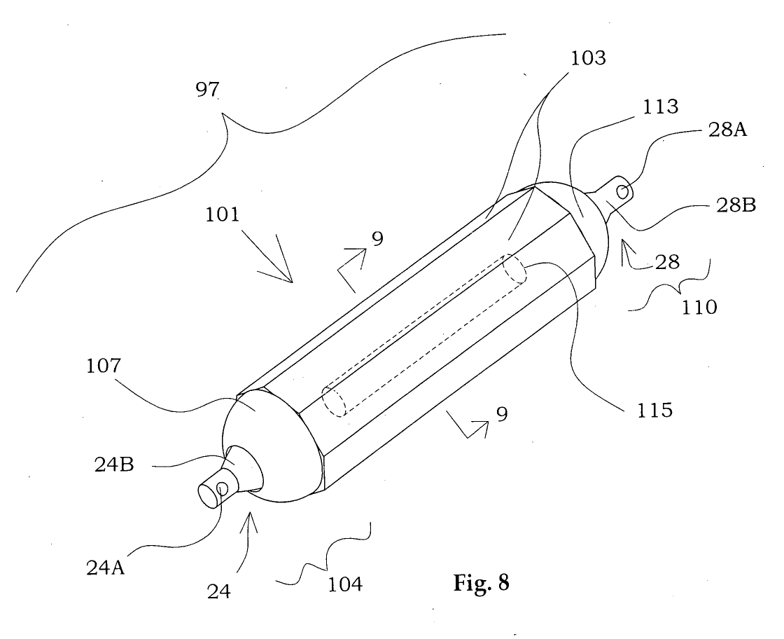

FIG. 8 is a perspective view of a fourth embodiment of the lure of the present invention 97 which is nearly identical to lure 11 of FIGS. 1 and 2 except that lure 97 includes a octagonal main housing 101 with angled outer walls 103. Like lure 11 of FIGS. 1 and 2, lure 97 includes a first swivel eyelet assembly 104 which may include swivel eyelet member 24 having eyelet 24A and body 24B and may also include first endcap 107. Lure 97 may also include a second eyelet assembly 110, which may include a fixed eyelet member 28 having eyelet 28A and body 28B, and may also include second endcap 113. A cylindrical tumbler member 115 is illustrated in dashed-line format inside main housing 101.

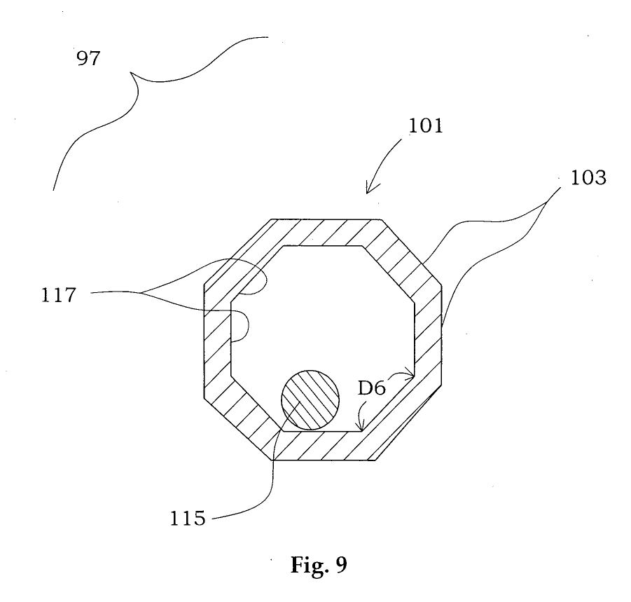

FIG. 9 a cross-sectional view taken along line 9-9 of FIG. 8 and illustrates lure 97 of FIG. 7 which illustrates angled outer walls 103 and angled inner walls 117 of main housing 101. Cylindrical tumbler member 115 is illustrated inside main housing 101. During use, tumbler member 115 strikes angled inner walls 117 of main housing 101, causing lure 97 to emit a series of fish-attractive noises or clicks. The diameter of tumbler member 115 may preferably be no greater than the width D6 of any flat surface on angled inner walls 117 so that the clicks emitted from lure 97 are distinct, low-frequency clicks of a type known to attract fish.

Note that although main housing 101 is illustrated as having angled outer walls 103, the exterior of main housing 101 may just as easily be a smooth surface such as that of main housing 13 of FIGS. 1 through 3. Likewise, although tumbler member 115 is illustrated as cylindrical, it may also be polygonal, i.e., rectangular, hexagonal, triangular, or octagonal, for example, and may be any of a variety of lengths.

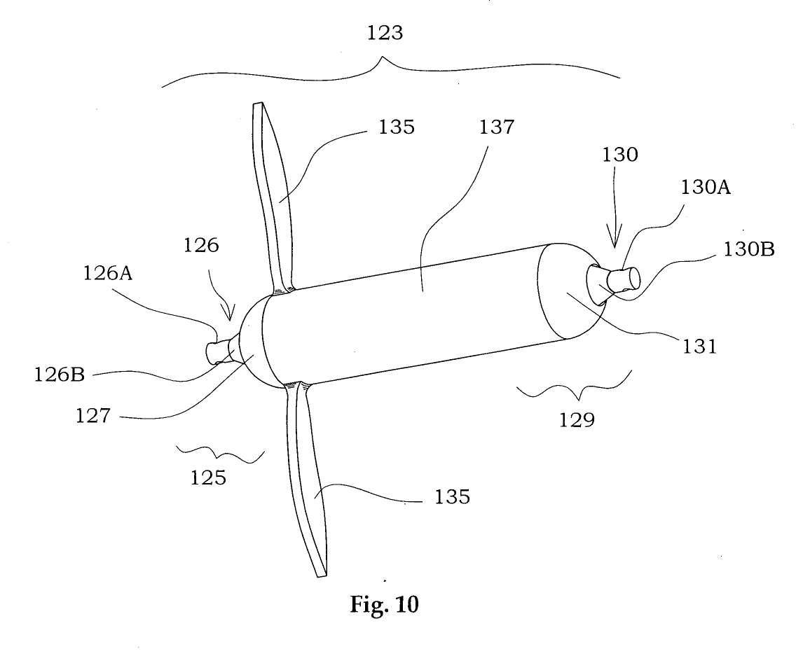

FIG. 10 is a perspective view of a fifth embodiment of the lure of the present invention 123 which is similar to lure 11 of FIGS. 1 through 3 except that it may include two swivel eyelet assemblies 125 and 129, each of which may include swivel eyelet members 126 and 130 (including eyelets 126A and 130A and bodies 126B and 130B, respectively) and endcaps 127 and 131, respectively. Lure 123 may also include propeller blades 135 fixed to one end of a main housing 137. Alternatively, propeller blades 135 may be attached to one of endcaps 127 or 131. Where propeller blades 135 are an extension of main housing 137, both eyelet members 126 and 130 may preferably be swivel eyelet members 126 and 130 to further decrease the possibility of line twisting and entanglement when lure 123 is in use.

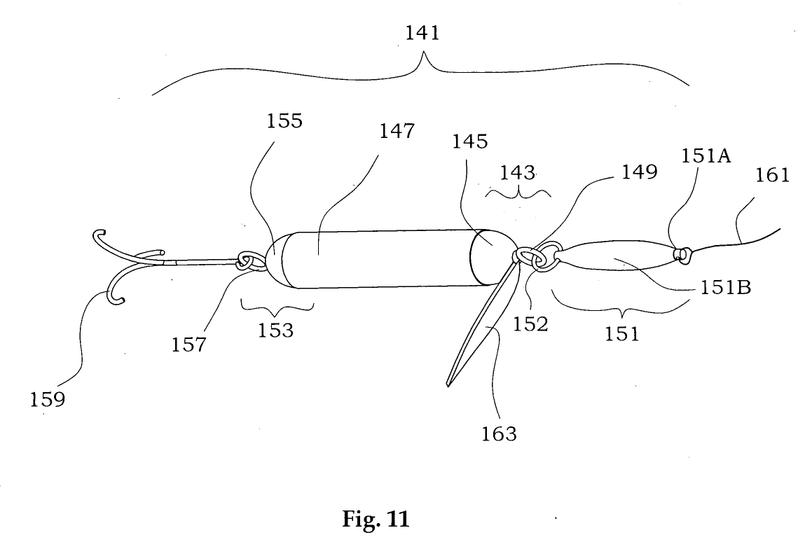

FIG. 11 is a perspective view of a sixth embodiment of the lure of the present invention 141 which is similar to lure 11 of FIGS. 1 through 3 except that first eyelet assembly 143 may include a first endcap 145 attached to main housing 147 and an o-ring 149 attached to first endcap 145 and to which a swivel eyelet member 151 (including eyelet 151A and body 151B) is shown attached via ring 152. Second eyelet assembly 153 may include second endcap 155 attached to main housing 147 and o-ring 157 attached to second endcap 155 and to which a hook 159 is shown attached. FIG. 11 further illustrates a fishing line 161 attached to eyelet 151A of swivel eyelet member 151, as well as a spinner blade 163 connected to lure 141 between first endcap 145 and o-ring 149. Spinner blade 163 drives rotation of main housing 147 as lure 141 is pulled through the water, but swivel eyelet member 151 may prevent translation of rotation of main housing 147 to line 161, thereby minimizing the possibility of twisting and entanglement of line 161. Although lure 141 is shown with swivel eyelet member 151 forward of main housing 147, note that a swivel eyelet member 151 may also be included between main housing 147 and hook 159 where rotation of hook 159 is undesirable.

Like all lures of the present invention, lure 141 can be used with any combination of fishing tackle which will allow the lures to operate as described. Any of the lures shown herein may be painted or otherwise coated or treated to suit a specified set of fishing conditions, for example with fluorescent paint to increase lure visibility in low-visibility water conditions. Likewise, the lures of the present invention may be made luminescent to achieve a fish scale effect. Any of the above-described lures may be used in fresh water or salt water, and the length and diameters of the lures may be varied accordingly to create a range of different sounds at varying frequencies. Likewise, the materials from which the lures are constructed may be any number of materials, such as wood, metal, and/or plastic. Coatings used for the lures may be directed toward attracting certain types of fish as well as toward the prevention of rust and/or corrosion as the case may be, depending on the fishing conditions in which the lures will be used.

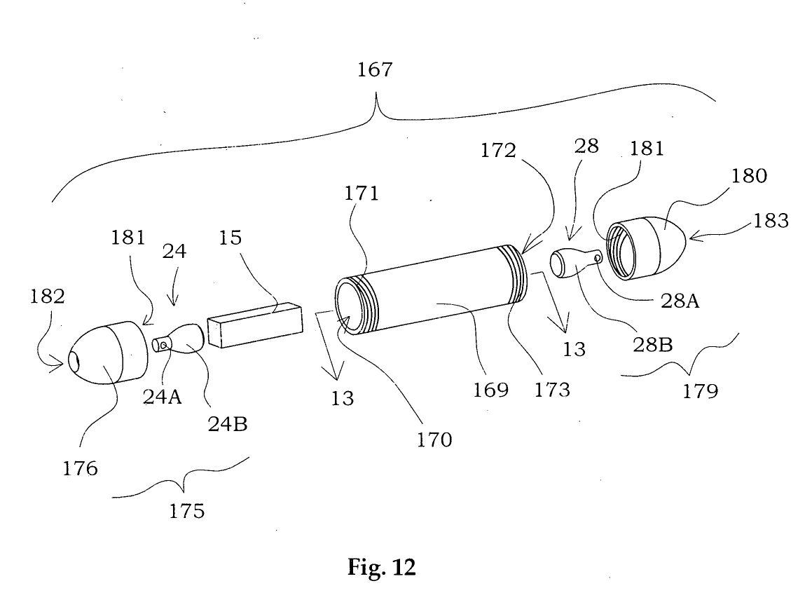

FIG. 12 is an exploded perspective view of a seventh embodiment of the lure of the present invention 167 which is similar to lure 11 of FIG. 1 except that main housing 169 has an open first end 170 adjacent a first set of threads 171 and a closed second end 172 adjacent a second set of threads 173. First eyelet assembly 175 may include first eyelet member 24 (having eyelet 24A and body 24B) and first endcap 176. Additionally, second eyelet assembly 179 may include second eyelet member 28 (including eyelet 28A and body 28B) and second endcap 180 having threads 181 by which it may be attached to main housing 169. Note that endcap 176 is identical to endcap 180, including threads 181. Endcaps 176 and 180 may include openings 182 and 183, respectively, through which eyelet members 24 and 28 may extend, respectively, when lure 167 is assembled. Main housing 169 with closed end 172 illustrates one alternative means of producing lure 167 which may maximize efficiency and minimize costs.

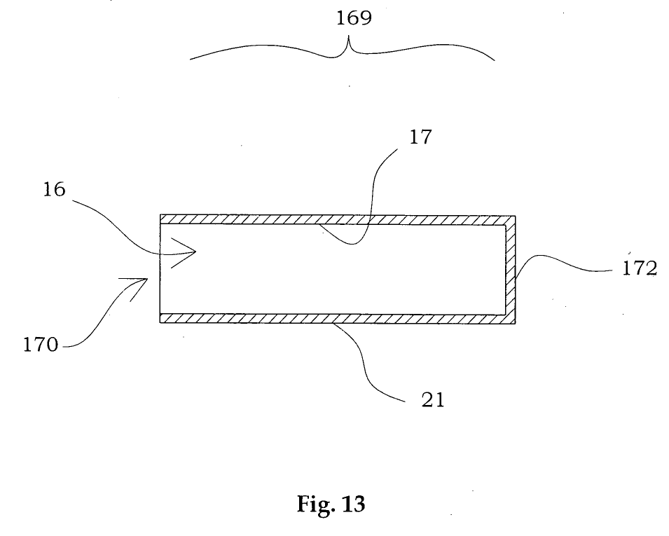

FIG. 13 is a cross-sectional view of cylindrical main housing 169 taken along line 13-13 of FIG. 12 which illustrates open first end 170, closed second end 172, outer surface 21, inner surface 17, and inner space 16.

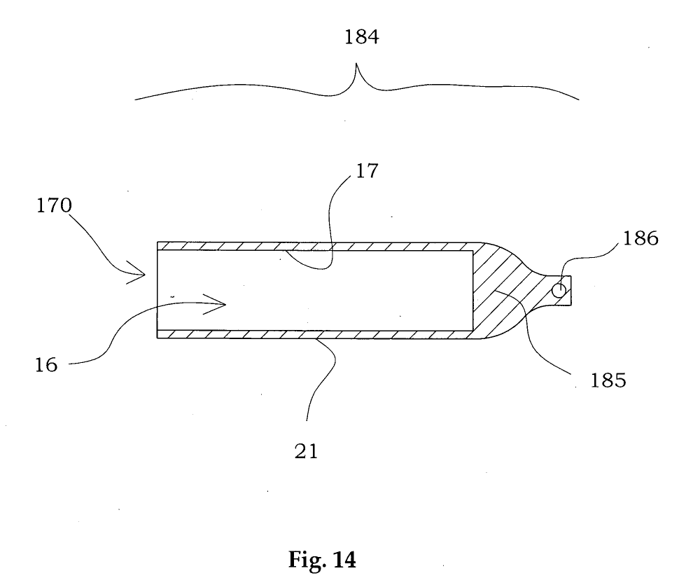

FIG. 14 is a cross-sectional view similar to that illustrated in FIG. 13 but illustrates an alternative cylindrical main housing 184 having a closed end 185 in which a fixed eyelet 186 is integrated.

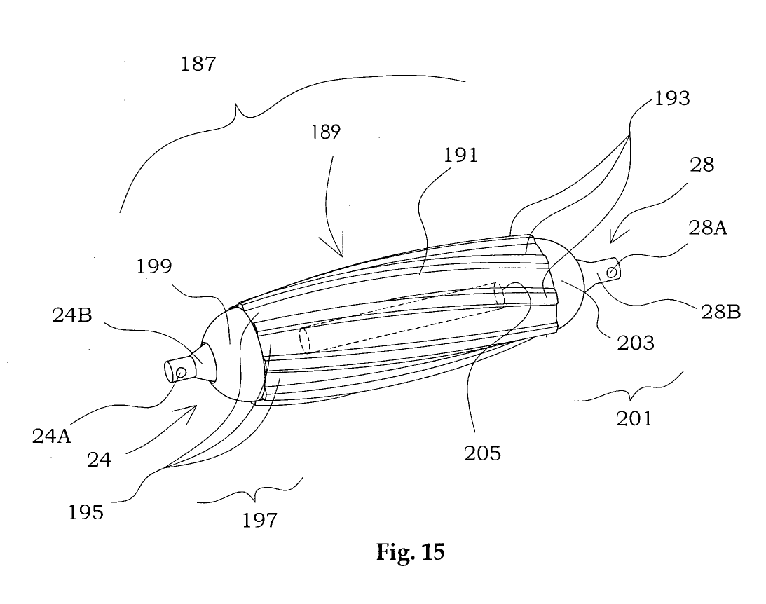

FIG. 15 is a perspective view of a eighth embodiment of lure of the present invention 187 which is nearly identical to lure 65 of FIG. 6 except that it includes a gear-shaped main housing 189 having an outer surface 191 characterized by longitudinally situated peaks 193 and troughs 195 which are spirally arranged. The spiral arrangement may help to facilitate rotation of main housing 189 when lure 187 is pulled through water. As shown, lure 187 may also include a first eyelet assembly 197 which may include eyelet member 24 (having eyelet 24A and body 24B) and endcap 199, and second eyelet assembly 201 which may include eyelet member 28 (having eyelet 28A and body 28B) and endcap 203. A cylindrical tumbler member 205 is illustrated in dashed line format inside main housing 189.

Finally, although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A lure comprising:
a main housing having an first end, a second end, an outwardly directed surface extending between said first and said second ends, an inwardly directed surface extending between said first end and said second end, and an inner space interiorly adjacent said inwardly directed surface;
a tumbler member fittable into said inner space of said main housing such that there is sufficient space between said inwardly directed surface and said tumbler member to allow said tumbler member to tumble freely within said inner space to produce a noise when said main housing is rotated; and
an eyelet assembly attached to said first end of said main housing such that said inner space containing said tumbler member is sealed to prevent ingress of water into said inner space when said lure is submerged.

2. The lure recited in claim 1 wherein said first eyelet assembly includes an eyelet member and an endcap.

3. The lure recited in claim 2 wherein said eyelet member has a body and an eyelet portion, and wherein said endcap includes an opening through which said eyelet portion of said eyelet member is fittable, said opening having a diameter which exceeds the maximum circumference of said body portion of said eyelet member to prevent said body portion of said eyelet member from passing through said opening.

4. The lure recited in claim 3 wherein said first eyelet assembly is a swivel eyelet assembly, such that said eyelet portion of said eyelet member is rotatable with respect to said body portion of said eyelet member, and wherein said swivel eyelet assembly is attachable to a fishing line such that, when said lure is interposed with tackle which tends to exert rotational force on said main housing with forward motion, said main housing is freely rotatable to produce a noise from tumbling of said tumbler with minimal translation of rotation to said fishing line.

5. The lure recited in claim 4 and further comprising an attachment structure attached to said second end of said main housing.

6. The lure recited in claim 5 wherein said attachment structure is an eyelet.

7. The lure recited in claim 5 wherein said main housing is cylindrical.

8. The lure recited in claim 5 wherein said main housing includes at least one inwardly protruding rib member extending longitudinally along said inwardly directed surface of said main housing.

9. The lure recited in claim 5 wherein said inwardly directed surface of said main housing has a polygonal shape.

10. The lure recited in claim 5 wherein said main housing includes interior and exterior ribs predominantly extending from said first end to said second end.

11. The lure recited in claim 10 wherein said exterior ribs on said main housing are spirally directed to facilitate rotation of said main housing.

12. The lure recited in claim 5 wherein said tumbler member is a cylinder.

13. The lure recited in claim 5 wherein said tumbler member is a polygonal cylinder.

14. The lure recited in claim 5 wherein said tumbler member is spherical.

15. The lure recited in claim 5 wherein said tumbler member is polygonal.

16. The lure recited in claim 15 wherein the largest outside diameter of said tumbler member relative to said inner space of said main housing is such that said tumbler member may tumble freely within said inner space when said main housing is rotated.

17. The lure recited in claim 16 wherein said main housing, said tumbler member, said eyelet assemblies are constructed of at least one of metal, plastic, composite, polymer, and wood.

18. The lure recited in claim 17 wherein said eyelet assembly is attached to said main housing by at least one of gluing, welding, soldering, rubberizing, and electroplating.

19. The lure recited in claim 18 wherein said first end of said main housing is an open end and said second end of main housing is a closed end.

20. The lure recited in claim 19 and further comprising a propeller member attached to said main housing for exerting rotational force on said main housing with forward motion.
